(19) United States
(12) Patent Application Publication
(10) Pub. No.: US 2009/0073146 A1
(43) Pub. Date: Mar. 19, 2009

(54) INTERFACE DEVICE AND DISPLAY DEVICE USING THE SAME

(75) Inventor: Chin-Tsao Chang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/116,218

(22) Filed: May 7, 2008

(30) Foreign Application Priority Data
Sep. 13, 2007 (TW) 96134187

(51) Int. Cl. G09G 5/00

(52) U.S. Cl. 345/204

(57) ABSTRACT

An interface device includes a first connector, a second connector, and a switch unit. The first connector and the second connector respectively have a first power pin and a second power pin. The switch unit is coupled between the first connector and the second connector. When one of the first and the second connectors receives a first multimedia signal, the switch unit controls whether or not to transmit the first multimedia signal to the other of the first and the second connectors according to a voltage level of the other of the first and the second power pins.

### CROSS-REFERENCE TO RELATED APPLICATION

This application claims the priority benefit of Taiwan application serial no. 96134187, filed on Sep. 13, 2007. The entirety of the above-mentioned patent application is hereby incorporated by reference herein and made a part of specification.

### BACKGROUND OF THE INVENTION

1. Field of the Invention

The present invention relates to an interface device. More particularly, the present invention relates to an interface device which may automatically transform a connector into an input port or an output port, and a display device using the same.

2. Description of Related Art

Presently, the video graphics array (VGA) interface is a main image data transmission interface, and is an indispensable connecting interface for a display device, such as a thin-film transistor liquid crystal display (TFT LCD) or a projector. A commonly used VGA interface is a three-row connector with 15 pins, which is also a commonly used image data transmission interface between a computer and the LCD.

During the application of the projector, due to a requirement of multi-input and multi-output, the projector needs to equip more than two connectors to respectively function as an input port and an output port. Furthermore, the projector may equip two or more connectors for input and one connector for output. However, excessive connectors may occupy a lot of space of the projector, and miniaturization of the projector cannot be achieved.

In addition, a single connector may only be used as the input port or the output port, and cannot be transformed or shared, which leads to a utilization limitation of the connecting interface. Only when the corresponding connectors are connected, the input signals may correctly be inputted or the output signals may correctly be received. Therefore, if the connectors may automatically detect a source of the signal and may automatically be transformed into the input port or the output port, not only is miniaturization of the display device achieved, but also utilization facility of the display device is improved.

### SUMMARY OF THE INVENTION

The present invention is directed to an interface device and a display device using the same, by which a connector of the interface device may be automatically transformed into an input port or an output port according to a transmission state of a signal. By such means, fewer connectors may achieve a greater effectiveness in coordination with different utilization requirements, and meanwhile utilization facility and space utilization of an electronic device may be improved.

Additional aspects and advantages of the present invention will be set forth in the description of the techniques disclosed in the present invention.

To achieve one of or all aforementioned and other advantages, an embodiment of the present invention provides an interface device including a first connector, a second connector, and a switch unit. The first connector and the second connector respectively have a first power pin and a second power pin. The switch unit is coupled between the first connector and the second connector. When the first connector receives a first multimedia signal, the switch unit transmits the first multimedia signal to the second connector according to a voltage level of the second power pin.

An embodiment of the present invention provides a display device including a signal processing unit, a first connector, a second connector, and a switch unit. The first connector and the second connector respectively have a first power pin and a second power pin. The switch unit is coupled among the first connector, the second connector, and the signal processing unit. When the first connector receives a first multimedia signal, the switch unit transmits the first multimedia signal to the signal processing unit according to a voltage level of the first power pin, and transmits the first multimedia signal to the second connector according to a voltage level of the second power pin.

An embodiment of the present invention provides a display device including a signal processing unit, a first connector, a second connector and a multiplexer. The second connector is coupled to the signal processing unit. The multiplexer is coupled among the first connector, the second connector, and the signal processing unit. When the second connector receives a multimedia signal and if the first connector is in an idle state, the multiplexer enables a transmission channel between the first connector and the second connector, so as to transmit the multimedia signal to the first connector.

In the present invention, the signal transmission state of the connectors may be judged based on the voltage levels of the power pins of the connectors, and the connectors may be automatically transformed into the input port or the output port according to the signal transmission state. Therefore, each connector may be used as the input port or the output port. Moreover, when the first connector receives the multimedia signal, and if the second connector is in the idle state, the interface device may set the second connector to serve as the output port and automatically output the multimedia signal received by the first connector. By such means, utilization of the interface device is more convenient, and meanwhile the number of connectors of the interface device is reduced and miniaturization of the device is achieved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram illustrating a display device according to a first embodiment of the present invention.

FIG. 2 is a schematic diagram illustrating a display device according to a second embodiment of the present invention.

FIG. 3 is a schematic diagram illustrating a display device according to a third embodiment of the present invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Generally, a single connector may only be used as an input port or an output port, and cannot be transformed or shared. In the following embodiments, the connectors of an interface device may not only function as the input port, but may also function as the output port, such that the number of the utilized connectors may be reduced, and space utilization may be improved.

### The First Embodiment

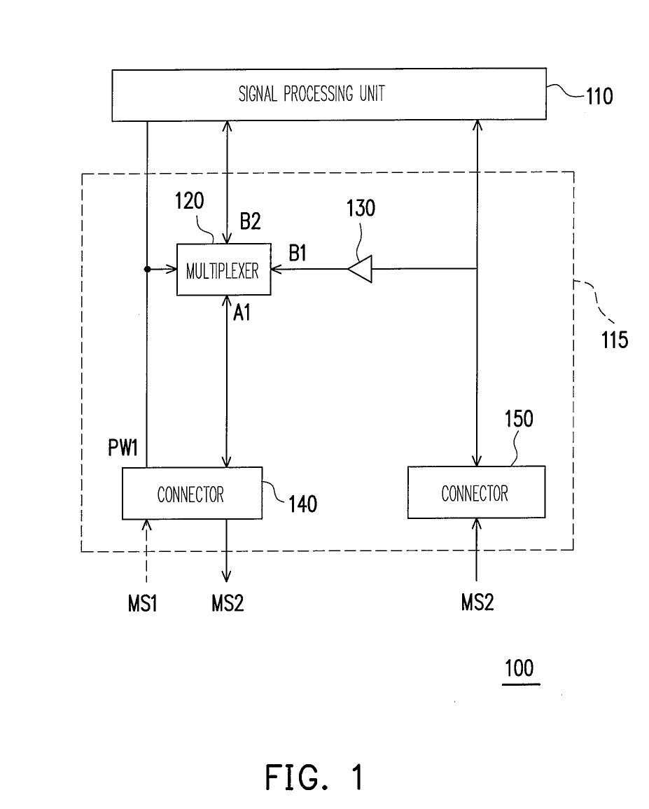

FIG. 1 is a schematic diagram illustrating a display device according to a first embodiment of the present invention. Referring to FIG. 1, the display device 100 includes a signal processing unit 110 and an interface device 115. The interface device 115 includes a multiplexer 120, a buffer 130, and connectors 140, 150. The signal processing unit 110 is coupled to the interface device 115. The signal processing unit 110 is capable of receiving a multimedia signal MS via the interface device 115, and processing and displaying the multimedia signal MS.

In the interface device 115, the multiplexer 120 is coupled among the connector 140, the connector 150, and the signal processing unit 110. The multiplexer 120 has two transmission channels, which are respectively from a pin A1 to a pin B1, and from the pin A1 to a pin B2, by which the signal processing unit 110 is coupled to the pin B2, and the buffer 130 is coupled between the connector 150 and the pin B1. A control end of the multiplexer 120 is coupled to a power pin PW1 of the connector 140, by which the multiplexer 120 may switch the transmission channels according to a voltage level of the power pin PW1 of the connector 140.

For example, the connector 140 is a VGA connector with 15 pins, then the power pin PW1 is a ninth pin (+5V) of the VGA connector. Therefore, when the multimedia signal is inputted from the connector 140, the power pin PW1 has a logic high level, and when the connector 140 is in an idle state, the power pin PW1 has a logic low level. When the power pin PW1 is logic high, the multiplexer 120 enables the transmission channel from the pin A1 to the pin B2 to transmit a received multimedia signal MS1 to the signal processing unit 110. When the power pin PW1 is logic low, the multiplexer 120 enables the transmission channel from the pin A1 to the pin B1 to transmit a multimedia signal MS2 received from the connector 150 to the connector 140. Now, the connector 140 is transformed into the output port, and may automatically output the multimedia signal MS2.

By channel switching of the multiplexer 120, the connector 140 may function as the input port or the output port. Meanwhile, during transformation of the transmission port, receiving or outputting of the signals may be performed without the aid of a calculation by the signal processing unit 110 or a software. Therefore, though the display device 100 of the present embodiment has only two connectors 140 and 150, the display device 100 may have two input port simultaneously or have one input port and one output port.

In addition, the signal processing unit 110 may also judge whether there is a signal input from the connector 140 according to the voltage level of the power pin PW1. The buffer 130 is just used for decreasing signal interference and improving strength of signal transmission between the multiplexer 120 and the connector 150. Therefore, if the connector 150 is directly coupled to the multiplexer 120, the present embodiment may have a same effect. Namely, whether or not the buffer 130 is utilized is not limited by the present invention.

### The Second Embodiment

In the aforementioned first embodiment, the connector 140 may function as the input port or the output port by channel switching of the multiplexer 120. Similarly, if a same circuit is applied between the connector 150 and the signal processing unit 110, the connector 140 and the connector 150 then may both have a transmission port transforming effect.

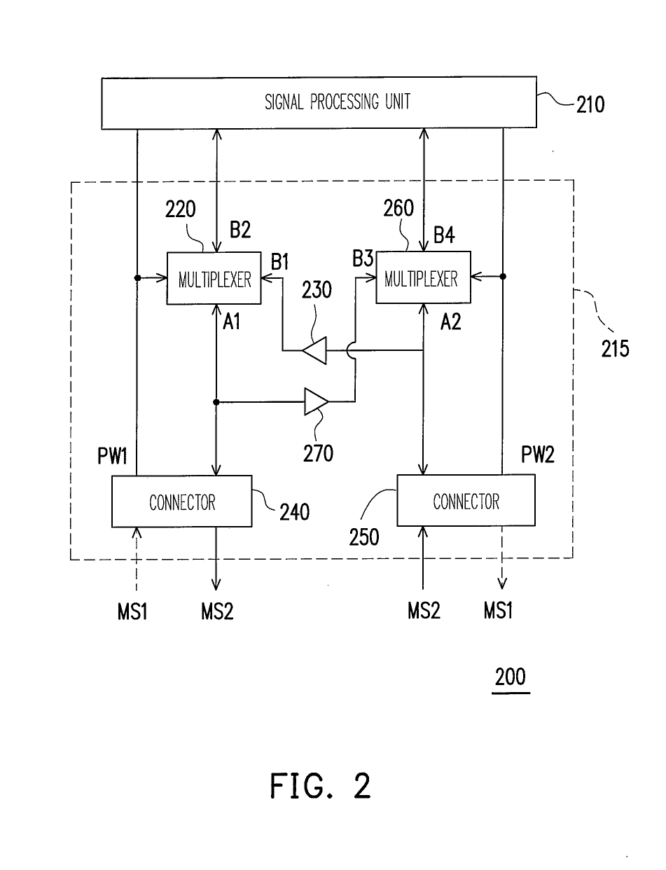

FIG. 2 is a schematic diagram illustrating a display device according to the second embodiment of the present invention. Referring to FIG. 1 and FIG. 2, a difference between the embodiments of FIG. 1 and FIG. 2 is that an interface device 215 of FIG. 2 further comprises a multiplexer 260 and a buffer 270. The multiplexer 260 has two transmission channels, which are respectively from a pin A2 to a pin B3, and from the pin A2 to a pin B4. The signal processing unit 210 is coupled to the pin B4, and the buffer 270 is coupled between the connector 240 and the pin B3. The control end of the multiplexer 260 is coupled to the power pin of the connector 250, by which the multiplexer 260 may switch the transmission channels according to the voltage level of a power pin PW2 of the connector 250.

Similar to a circuit operation of the first embodiment, when the multimedia signal MS2 is input through the connector 250, the power pin PW2 has a logic high level, and when the connector 250 is in the idle state, the power pin PW2 has a logic low level. When the power pin PW2 is logic high, the multiplexer 260 enables the transmission channel from the pin A2 to the pin B4 to transmit the received multimedia signal MS2 to the signal processing unit 210. When the power pin PW2 is logic low, the multiplexer 260 enables the transmission channel from the pin A2 to the pin B3 to transform the connector 250 into the output port. Now, if the connector 240 receives the multimedia signal MS1, the multimedia signal MS1 may be transmitted to the signal processing unit 210 via a multiplexer 220, and may be transmitted to the connector 250 via the multiplexer 260.

In other words, when the multimedia signal MS1 is received via the connector 240, and if the connector 250 is in the idle state, the connector 250 may automatically output the multimedia signal MS1. Similarly, when the multimedia signal MS2 is received via the connector 250, and if the connector 240 is in the idle state, the connector 240 may automatically output the multimedia signal MS2. Wherein, the buffers 230 and 270 are used for strengthening a signal-noise ratio of the multimedia signals MS1 and MS2 after a long way transmission, so as to improve a signal quality.

Therefore, the connectors 240 and 250 included in the display device 200 of the present embodiment may both have the transmission port transforming effect. In other words, when one of the connectors is in the idle state, the multiplexer may automatically transform the connector into the output port, so as to output the multimedia signal received from another one of the connectors. Certainly, the connectors 240 and 250 may simultaneously function as input ports and simultaneously receive the multimedia signals MS1 and MS2.

It should be noted that the connectors 240 and 250 are not limited to the VGA connectors with 15 pins. For example, the connectors 240 and 250 may also be digital visual interface (DVI) connectors. In this case, the power pins of the connectors 240 and 250 are respectively fourteenth pins (+5V) of the DVI connectors. Therefore, types of the connectors are not limited by the present invention, and it should be acknowledged by those skilled in the art that the transmission state of the signals may be judged according to the voltage levels of the power pins, and the connectors may be transformed into the input port and the output port accordingly.

### The Third Embodiment

As to the channel switching, as long as the transmission channels of the multimedia signals MS1 and MS2 may be switched according to the voltage levels of the power pins PW1 and PW2, it is within the scope of the present invention. The multiplexers are not indispensable components for the present invention. The multiplexers may be substituted by general electric components, which may be easily deduced by analogy by those skilled in the art according to a disclosure of the present invention, and therefore the detailed description thereof will no be repeated.

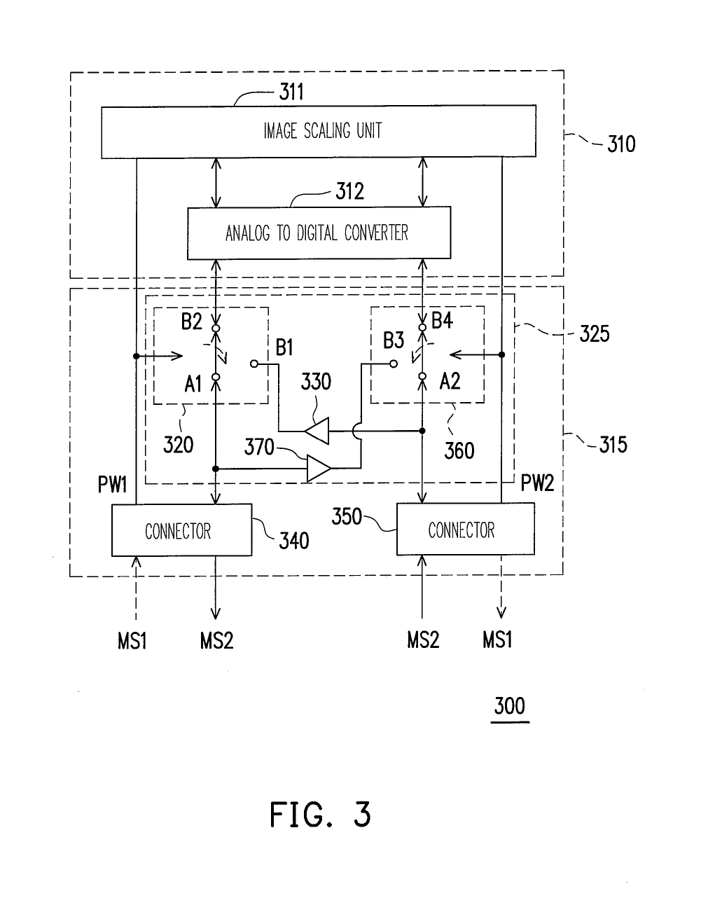

FIG. 3 is a schematic diagram illustrating a display device according to the third embodiment of the present invention. Referring to FIG. 3, the display device 300 includes a signal processing unit 310 and an interface device 315. The signal processing unit 310 further includes an analog to digital converter 312 and an image scaling unit 311. A main difference between the embodiments of FIG. 3 and FIG. 2 is that in the embodiment of FIG. 3, a switch unit 325 is used for substituting the multiplexers 220 and 260, and buffers 230 and 270 of FIG. 2.

The analog to digital converter 312 is coupled between the image scaling unit 311 and the switch unit 325. The switch unit 325 further includes a first switch unit 320, a second switch unit 360, and buffers 330 and 370. The first switch unit 320 is coupled between the analog to digital converter 312 and the connector 340, and is coupled to the second switch unit 360 via the buffer 370. The second switch unit 360 is coupled between the analog to digital converter 312 and the connector 350, and is coupled to the first switch unit 320 via the buffer 330.

The first switch unit 320 switches the two transmission channels according to the voltage level of the power pin PW1, wherein the two transmission channels are respectively from the a A1 to a pin B1, and from the pin A1 to a pin B2. The second switch unit 360 switches the two transmission channels according to the voltage level of the power pin PW2, wherein the two transmission channels are respectively from a pin A2 to a pin B3, and from the pin A2 to a pin B4.

When the connector 340 receives the multimedia signal MS1, the power pin PW1 has a logic high level, and the first switch unit 320 enables the transmission channel from the pin A1 to the pin B2 to transmit a received multimedia signal MS1 to the signal processing unit 310. When the connector 340 is in an idle state, the power pin PW1 has a logic low level, and the first switch unit 320 enables the transmission channel from the pin A1 to the pin B1. Now, the connector 340 is the output port, and may automatically output the multimedia signal MS2 received from the connector 350. The circuit operations of the second switch unit 325 and the connector 350 may be deduced by analogy, and therefore the detailed description thereof will not be repeated.

In addition, by channel switching of the first switch unit 320 and the second switch unit 360, the connectors 340 and 350 may be simultaneously transformed into the output port or the input port. For example, when the multimedia signals MS1 and MS2 are simultaneously input, the connectors 340 and 350 may be simultaneously transformed into the input port.

In another embodiment of the present invention, the interface device 315 may also be applied to an output interface of a display card, and whether or not the multimedia signals is input may also be judged according to the voltage levels of the power pins of the connectors. When the multimedia signal is received, the corresponding connector is set as the input port, and the other idle connector is set as the output port. Therefore, though only two connectors 340 and 350 are utilized in the present embodiment, the two connectors may simultaneously function as two input ports or function as one input port and one output port.

In summary, the interface devices of in the aforementioned embodiments may judge the signal transmission state according to the voltage levels of the power pins of the connectors, and may transform the connectors into the input port or the output port accordingly. When one of the connectors receives the multimedia signal, the multimedia signal may be output to an external display device through the connector having the idle state. Therefore, each connector may function as the input port or the output port, so as to overcome a shortage in a conventional technique that a single connector can only function as the input port or the output port. Meanwhile, the required transmission channels may be switched according to a judgment of the signal transmission state based on the voltage levels of the power pins of the connectors, without the aid of a calculation by the signal processing unit and the software, such that a working efficiency of the system is greatly improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An interface device for a display device, comprising:
a first connector, having a first power pin;
a second connector, having a second power pin; and
a switch unit, coupled between the first connector and the second connector,
wherein when one of the first connector and the second connector receives a first multimedia signal, the switch unit controls whether or not to transmit the first multimedia signal to the other of the first and the second connectors according to a voltage level of the power pin of the other of the first and second connectors.

2. The interface device as claimed in claim 1, wherein when the first connector receives the first multimedia signal, and if the second power pin is logic low, the switch unit transmits the first multimedia signal to the second connector.

3. The interface device as claimed in claim 1, wherein when the second connector receives the first multimedia signal, and if the first power pin is logic low, the switch unit transmits the first multimedia signal to the first connector.

4. The interface device as claimed in claim 1, wherein the switch unit comprises:
a first switch unit, coupled between the first connector and the second connector; and
a second switch unit, coupled between the second connector and the first connector,
wherein when the first power pin is logic low, the first switch unit enables a transmission channel between the first connector and the second connector, and when the second power pin is logic low, the second switch unit enables the transmission channel between the first connector and the second connector.

5. The interface device as claimed in claim 4, wherein when the first power pin is logic high, the first switch unit turns off the transmission channel between the first connector and the second connector, and when the second pin is logic high, the second switch unit turns off the transmission channel between the first connector and the second connector.

6. The interface device as claimed in claim 4, wherein the switch unit further comprises:
a first buffer, coupled between the first switch unit and the second connector; and
a second buffer, coupled between the second switch unit and the first connector.

7. The interface device as claimed in claim 4, wherein the first switch unit and the second switch unit are respectively a multiplexer.

8. The interface device as claimed in claim 1, wherein the first connector and the second connector are respectively a video graphics array connector, and the first power pin and the second power pin are respectively a ninth pin of the corresponding video graphics array connector.

9. A display device, comprising:
a signal processing unit;
a first connector, having a first power pin;
a second connector, having a second power pin; and
a switch unit, coupled among the first connector, the second connector, and the signal processing unit,
wherein when one of the first connector and the second connector receives a first multimedia signal, the switch unit transmits the first multimedia signal to the signal processing unit according to a voltage level of the power pin of one of the first connector and the second connector, and controls whether or not to transmit the first multimedia signal to the other of the first and the second connectors according to a voltage level of the power pin of the other of the first and the second connectors.

10. The display device as claimed in claim 9, wherein when the first connector receives the first multimedia signal, and if the second power pin is logic low, the switch unit transmits the first multimedia signal to the second connector.

11. The display device as claimed in claim 9, wherein when the second connector receives the first multimedia signal, and if the first power pin is logic low, the switch unit transmits the first multimedia signal to the first connector.

12. The display device as claimed in claim 9, wherein the switch unit comprises:
a first switch unit, for switching a first channel and a second channel according to the voltage level of the first power pin, the first channel is coupled between the first connector and the signal processing unit, and the second channel is coupled between the first connector the second connector; and
a second switch unit, for switching a third channel and a fourth channel according to the voltage level of the second power pin, the third channel is coupled between the second connector and the signal processing unit, and the fourth channel is coupled between the second connector and the first connector,
wherein when the first power pin is logic low, the first switch unit enables the second channel, when the first power pin is logic high, the first switch unit enables the first channel, when the second power pin is logic low, the second switch unit enables the fourth channel, and when the second power pin is logic high, the second switch unit enables the third channel.

13. The display device as claimed in claim 12, wherein the switch unit further comprises:
a first buffer, coupled between the first switch unit and the second connector; and
a second buffer, coupled between the second switch unit and the first connector.

14. The display device as claimed in claim 12, wherein the first switch unit and the second switch unit are respectively a multiplexer.

15. The display device as claimed in claim 9, wherein the first connector and the second connector are respectively a video graphics array connector, and the first power pin and the second power pin are respectively a ninth pin of the corresponding video graphics array connector.

16. The display device as claimed in claim 9, wherein the signal processing unit further comprises:
an analog to digital converter, coupled to the switch unit; and
an image scaling unit, coupled to the analog to digital converter.

17. A display device, comprising:
a signal processing unit;
a first connector;
a second connector, coupled to the signal processing unit; and
a multiplexer, coupled among the first connector, the second connector and the signal processing unit,
wherein when the second connector receives a first multimedia signal, and if the first connector is in an idle state, the multiplexer enables a transmission channel between the first connector and the second connector, so as to transmit the multimedia signal to the first connector.

18. The display device as claimed in claim 17, wherein the multiplexer determines whether or not the first connector is in the idle state according to a voltage level of a power pin of the first connector, and if the power pin is logic low, it represents the first connector is in the idle state.

19. The display device as claimed in claim 18, wherein the first connector and the second connector are respectively a video graphics array connector, and the power pin is a ninth pin of the video graphics array connector.

20. The display device as claimed in claim 17, wherein the display device further comprises a buffer coupled between the multiplexer and the second connector.
